(19) United States
(12) Patent Application Publication
(10) Pub. No.: US 2004/0226782 A1
(43) Pub. Date: Nov. 18, 2004

(54) Hinge apparatus of mobile terminal

(76) Inventor: Joon-Hee Lim, Ichon-shi (KR)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/749,496

(22) Filed: Dec. 31, 2003

(30) Foreign Application Priority Data
May 13, 2003 (KR) 2003-30180

(51) Int. Cl. F16D 55/46

(52) U.S. Cl. 188/72.2

(57) ABSTRACT

Disclosed is a hinge apparatus of a mobile terminal having a deceleration section at a specific and preset time in the turning of a swinging part thereof. The hinge apparatus having a deceleration section includes: a rotary shaft; a fixed cam mounted on one side of the rotary shaft; a moving cam mounted on one side of the fixed cam for being straightly moved along the rotary shaft via a reciprocating motion taking place between the fixed cam and the moving cam; an elastic means for supporting the moving cam to stretch and return to original position; a housing for lodging the moving cam and the elastic means; and a frictional force generation means mounted on one side of the housing for generating frictional force at a predetermined interval during a reciprocating motion taken place between the fixed cam and the moving cam.

### FIELD OF THE INVENTION

The present invention relates to a hinge apparatus joining two parts of a mobile terminal together and allowing turning of a swinging part thereof; and, more particularly, to a hinge apparatus of a mobile terminal having a deceleration section at a predetermined time in the turning of a swinging part thereof wherein frictional force is applied to reduce the turning momentum of the swinging part, thereby minimizing the energy exerted on the frame of the mobile terminal on impact while decreasing the risk of damage being done to the mobile terminal as the two parts thereof swing open or closed.

### DESCRIPTION OF RELATED ART

With the emergence of new technologies, commodities with a built-in Liquid Crystal Display (LCD) and a keyboard panel, such as a mobile terminal and a Personal Digital Assistant (PDA) are under development in a miniaturized form and in a many varieties.

The mobile terminal is manufactured either in a folder form or flip form. The folder form of the mobile terminal includes a display unit and a keypad unit attached to each other with a hinge. As to the mobile terminal in the folder form, hinge apparatuses in a many varieties are either currently in use or under development with the aim of attaining the smooth turning of the swinging part of the display unit and the keypad unit.

The frame of the mobile terminal with existing conventional hinges is easily damaged by frequently folding up and unfolding the mobile terminal. For overcoming the above mentioned problem of the mobile terminal with conventional hinges, additional plastic skin of frame is applied to the frame or new durable martial is used for manufacturing the frame of the mobile terminal.

However, the mobile terminal with conventional hinges is still easily cracked or broken since the impact energy generated by frequent folding up and unfolding the mobile terminal is comparatively large.

### SUMMARY OF THE INVENTION

It is, therefore, an object of the present invention to provide a hinge apparatus of a mobile terminal having a deceleration section at a predetermined time in the turning of a swinging part thereof wherein frictional force is applied to reduce the turning momentum of the swinging part, thereby minimizing the energy exerted on the frame of the mobile terminal on impact while decreasing the risk of damage being done to the mobile terminal as the two parts thereof swing open or closed.

In accordance with an aspect of the present invention, there is provided a hinge apparatus having a deceleration section, including: a rotary shaft; a fixed cam mounted on one side of the rotary shaft; a moving cam mounted on one side of the fixed cam for being straightly moved along the rotary shaft via a reciprocating motion taking place between the fixed cam and the moving cam; an elastic means for supporting the moving cam to stretch and return to original position; a housing for lodging the moving cam and the elastic means; and a frictional force generation means mounted on one side of the housing for generating frictional force at a predetermined interval during a reciprocating motion taken place between the fixed cam and the moving cam.

### BRIEF DESCRIPTION OF THE DRAWINGS

The above and other objects and features of the present invention will become apparent from the following description of the preferred embodiments given in conjunction with the accompanying drawings, in which:

FIG. 1 is a perspective view of a hinge apparatus mounted on a mobile terminal having a deceleration section at a specific time in the turning of a swinging part thereof in accordance with a preferred embodiment of the present invention;

FIG. 2A is a perspective view of a fixed friction plate in accordance with a preferred embodiment of the present invention;

FIG. 2B is a cross-sectional view of a moving friction plate in accordance with a preferred embodiment of the present invention;

FIG. 2C is a plane/side view of a fixed friction plate in accordance with a preferred embodiment of the present invention; and

FIG. 3A and FIG. 3B are a plane view and a side view of a moving friction plate respectively in accordance with a preferred embodiment of the present invention.

### DETAILED DESCRIPTION OF THE INVENTION

Other objects and aspects of the invention will become apparent from the following description of the embodiments with reference to the accompanying drawings, which is set forth hereinafter.

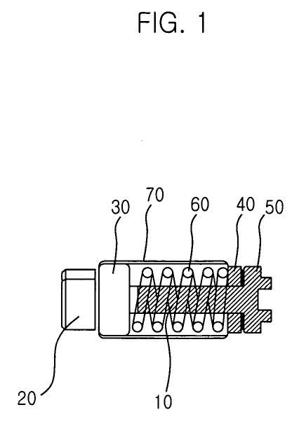

FIG. 1 is a perspective view of a hinge apparatus mounted on a mobile terminal having a deceleration section at a specific time in the turning of a swinging part thereof in accordance with an embodiment of the present invention.

As shown in FIG. 1, the hinge apparatus of the mobile terminal having a deceleration section at a specific time in the turning of the swinging part includes a rotary shaft 10; a fixed cam 20 mounted on the one side of the rotary shaft 10; a moving cam 30 adjoining the fixed cam 20 on one side and moving in a straight line along the rotary shaft 10 via a reciprocating motion taking place between the fixed cam 20 and the moving cam 30; an elastic device 60 for supporting the moving cam 30 with the ability to stretch and return to the original position thereof; a housing 70 for lodging the moving cam 30 and the elastic device 60; and a frictional force generation device mounted on the one side of the housing 70 for generating frictional force at a specific interval during a reciprocating motion taken place between the fixed cam 20 and the moving cam 30.

The primary function of the fixed cam 20 and the moving cam 30 is such that the reciprocating motion takes place between the two counterparts. The fixed cam 20 is in the shape of a flat board with a series of equally spaced protrusions and troughs along one side. The moving cam 30 has a hole therein at the center to be inserted by the rotary shaft 10 and a series of peaks and troughs formed thereon.

The frictional force generation device includes a moving friction plate 40 adjoining the rotary shaft 10 on the other side and a fixed friction plate 50 placed on the one side of the moving friction plate 40 on which frictional force is exerted.

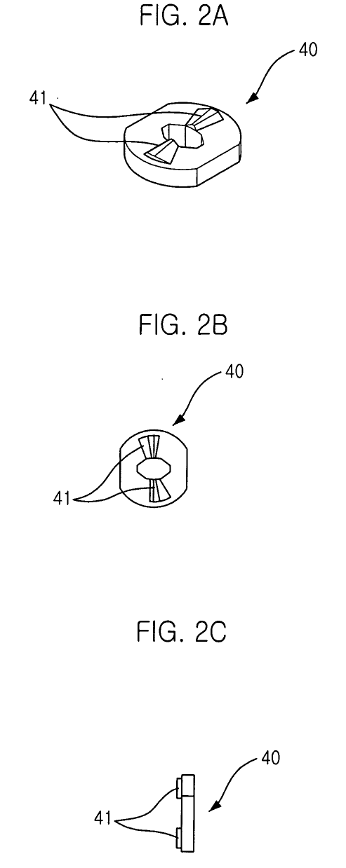

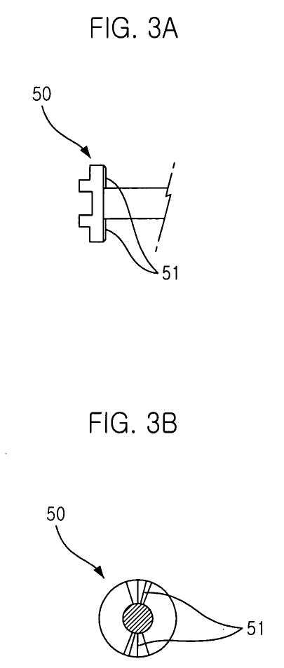

The detailed description of the moving friction plate 40 and the fixed friction plate 50 in conjunction with FIGS. 2A and 3B will be given as follows. FIGS. 2A and 2C are a perspective view and a plane/side view of the fixed friction plate 50 respectively. FIGS. 3A and 3B are a plane view and a side view of a moving friction plate respectively in accordance with the embodiment of the present invention.

As shown in FIGS. 2A and 2B, the moving friction plate 40 is in the shape of a flat board with equally-spaced and many-sided decelerating protrusions 41 stretching in a radial direction toward the edge of the plate on one side.

The fixed friction plate 50 is in the shape of a flat board with equally-spaced and many-sided decelerating protrusions 51 stretching in a radial direction toward the edge of the plate on one side facing the moving friction plate 40.

The decelerating protrusions 41 and 51 are shaped in such a way that the surfaces thereof lie at an angle to the horizontal so as to optimize the rotary motion of the plates involved. In addition, the arrangement of the decelerating protrusions 41 and 51 can be such that the protrusions are formed on either one or both of the two plates, namely the moving friction plate 40 and the fixed friction plate 50.

Furthermore, the fixed friction plate 50 can be removed notwithstanding the above description of the fixed friction plate 50 and a view thereof illustrates a structure of the hinge apparatus having the fixed friction plate 50.

As to the reciprocating motion taken place between the moving friction plate 40 and the fixed friction plate 50, the decelerating protrusions 41 and 51 thereon become engaged with each other so as to reduce the turning momentum, thereby minimizing the energy exerted on the frame of a terminal on impact as the terminal swings open or close and, specifically, as the terminal is about to open or close.

On the other hand, the housing 70 is shaped in such a way that the rotation is disabled, whereas the rectilinear motion is enabled as regards the moving cam 30 and the fixed friction plate 50. Precisely, the outer surface of the housing 70 is polygonal in shape so that the rectilinear motion of the fixed cam 20 and the fixed friction plate 50 is enabled. The elastic device 60 is a series of connected and spiral-shaped rings.

The operation of the hinge apparatus in the mobile terminal having a deceleration section at a specific time in the turning of the swinging part in accordance with an embodiment of the present invention is described in details as follows.

As a folding unit swings on a main body unit, the fixed cam 20 rotates, thereby producing a reciprocating motion in the moving cam 30 moving in a straight line and at the same time compressing the elastic device 60 and, in turn, rotating the fixed friction plate 50.

Just before a user turns the folding unit at an angle suitable for making a phone call, the decelerating protrusions 51 on the fixed friction plate 50 engage with the decelerating protrusions 41 on the moving friction plate 40, thereby reducing the turning momentum of the folding unit.

Furthermore, provided that the decelerating protrusions 51 on the fixed friction plate 50 and the decelerating protrusions 41 on the moving friction plate 40 remain in contact as the moving cam 30 and the fixed cam 20 pass by a so-called fixed point while the user turns the folding unit at an angle suitable for making a phone call, the restoring force of the elastic device 60 makes the moving cam 30 return to its original position, thereby slowing down the instantaneous turning motion of the folding unit via the frictional force exerted by the decelerating protrusions 41 and 51.

On the other hand, as the folding unit swings closed, the same frictional force as recited in the above come into action just before the mobile terminal is folded up, thereby slowing down the reciprocating motion taken place between the moving cam 30 and the fixed cam 20.

The effect of the present invention as recited in the above is briefly summarized herein in such a way that the speed at which the swinging part of a mobile terminal as such turns is controlled, that is to say the turning momentum of the swinging part thereof is reduced, thereby minimizing the energy exerted on the frame of the mobile terminal on impact while decreasing the risk of damage, such as case cracks and a coating of paint being peeled away, being done thereto as the mobile terminal in a folder form swings open or closed.

While the present invention has been described with respect to certain preferred embodiments, it will be apparent to those skilled in the art that various changes and modifications may be made without departing from the scope of the invention as defined in the following claims.

What is claimed is:

1. A hinge apparatus having a deceleration section, comprising:
a rotary shaft;
a fixed cam mounted on one side of the rotary shaft;
a moving cam mounted on one side of the fixed cam for being straightly moved along the rotary shaft via a reciprocating motion taking place between the fixed cam and the moving cam;
an elastic means for supporting the moving cam to stretch and return to original position;
a housing for lodging the moving cam and the elastic means; and
a frictional force generation means mounted on one side of the housing for generating frictional force at a predetermined interval during a reciprocating motion taken place between the fixed cam and the moving cam.

2. The hinge apparatus as recited in claim 1, wherein the frictional force generation means includes a fixed friction plate mounted on another side of the rotary shaft for contacting to another side of the housing.

3. The hinge apparatus as recited in claim 1, wherein the frictional force generation means includes:
a fixed friction plate mounted another side of the rotary shaft; and
a moving friction plate mounted on one side of the fixed friction plate for being straightly moved along the rotary shaft.

4. The hinge apparatus as recited in claim 3, wherein the fixed friction plate and the moving friction plate are formed in the shape of a flat board having equally-spaced and many-sided decelerating protrusions stretching in a radial direction toward the edge of the plate on one side and said decelerating protrusions are shaped in such a way that the surfaces thereof lies at an angle to the horizontal and formed on either one or both of the fixed friction plate and the moving friction plate.

5. The hinge apparatus as recited in claim 1, wherein said decelerating protrusions are formed in position at a particular time when the fixed cam and the moving cam pass by a fixed point during a reciprocating motion taken place between the fixed cam and the moving cam.
